(19) United States
(12) Patent Application Publication
(10) Pub. No.: US 2004/0265437 A1
(43) Pub. Date: Dec. 30, 2004

(54) Vegetable food product with integrated dressing container

(76) Inventor: Brian Rianda, Salinas, CA (US)

Correspondence Address: National IP Rights Center, LLC, Suite 400, 550 Township Line Road, Blue Bell, PA, 19422, US

(21) Appl. No.: 10/858,493

(22) Filed: Jun. 1, 2004

Related U.S. Application Data
(60) Provisional application No. 60/474,142, filed on May 29, 2003.

(51) Int. Cl. A23B 4/00

(52) U.S. Cl. 426/120

(57) ABSTRACT

A vegetable food product is disclosed and a method of producing the product. The vegetable food product includes a head of lettuce, a container of dressing or condiment disposed within a cored opening in the head of lettuce, and a wrapper around the head of lettuce. The vegetable food product is produced by removing the core of the head of lettuce, inserting a container of dressing or condiment into the cored hole, then wrapping the head of lettuce and the container of dressing or condiment.

### CLAIM OF PRIORITY

This application claims priority to U.S. Application No. 60/474,142, filed May 29, 2003.

### FIELD OF THE INVENTION

The present invention is directed to the field of salads and specifically combinations of salads and dressings or condiments.

### BACKGROUND OF THE INVENTION

Ready to eat foods are a rapidly growing subset of the grocery business. As more and more families have less and less time to prepare food, prepared and semi-prepared food products have sprung up to allow people to enjoy prepared foods without the added hassle of having to completely prepare them.

The health conscious in society know that salads are a staple of a balanced diet and that ready to eat, or easy to prepare salads are very popular. To this end, a fair number of prepared and semi-prepared salads have been introduced on the market.

For example, U.S. Pat. No. 6,302,268 discloses a container for salad and includes a base, a removable cover and a chamber insert which projects through the cover and into the container. The container is sealed by a removable cap. Pressure applied by a user to a portion of the chamber insert releases the cap and allows salad dressing or condiment or condiment which is stored in an enclosure in the chamber member to flow onto salad ingredients which are in the base. Shaking the container facilitates uniform mixing of the salad dressing or condiment with the salad ingredients.

Additionally, U.S. Pat. No. 5,035,320 discloses a dispenser for dispensing dispensable substance or substances comprising carrier structure, elongated pusher structure on the carrier structure, elongated receptacle structure beneath the pusher structure and on the carrier structure, there being an elongated zone or zones between the pusher structure and receptacle structure to receive the dispensable substance or substances, the pusher structure being selectively manually deflectable toward the receptacle structure, at selected locations along the length of the pusher structure length, the receptacle structure being frangible at selected lengthwise locations corresponding to the selected locations along the length of the pusher structure, and in response to deflection of the pusher structure, whereby dispensing of the dispensable substance or substances occurs at related lengthwise locations of the receptacle structure including at least one pusher having length which is at least about three times its width, and having arching extent over its width so as to project upwardly from the carrier structure and including a deflector integral with such arching extent to project downwardly in the arching extent toward the receptacle structure, along the elongated length of the pusher, whereby a user can progressively run his finger lengthwise along the pusher to deflect the pusher to an extent corresponding to the amount of dispensable substance to be dispensed from the receptacle structure in response to deflector engagement with an opening of the receptacle structure.

However, there is a need for a self contained salad product the does not require shredding the single head, and includes the dressing or condiment with the single head of lettuce. Furthermore, it would be advantageous to have a self contained salad product that could be easily packed in the field so as to utilize already existing wrapping techniques for produce.

### OBJECTS AND SUMMARY OF THE INVENTION

It is an object of the present invention to provide a vegetable food product that is self-contained, with lettuce that does not require shredding, and a container of dressing or condiment.

It is a further object of the present invention to provide a vegetable food product that does not require much effort to prepare and transport as the dressing or condiment and head of lettuce are self contained within a wrapping.

It is yet a further object of the present invention to provide a method of easily preparing a vegetable food product in the field that includes a container of dressing or condiment wrapped within the product.

In accordance with a first aspect of the present invention, a novel vegetable food product is provided. The vegetable food product includes a head of lettuce, or other vegetable such as broccoli, cauliflower, cabbage or leaf lettuce and a container of dressing or condiment mounted within the vegetable.

In accordance with another aspect of the present invention, a novel vegetable food product is provided that is easy to prepare and transport. The vegetable food product includes a head of lettuce (such as iceberg lettuce) and at least one container of dressing or condiment wrapped along with the head of lettuce inside of a wrapper.

In accordance with yet another aspect of the present invention, a novel method for preparing a vegetable food product is provided. The method includes coring a head of lettuce, then inserting a container of dressing or other condiment within the core of the head of lettuce, and wrapping the head of lettuce and container of dressing or condiment.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a perspective view of a vegetable food product in accordance with a preferred embodiment of the present invention.

FIG. 2 is a perspective view of an alternative embodiment of a vegetable food product in accordance with the present invention.

### DETAILED DESCRIPTION OF THE PREFERRED EMBODIMENT

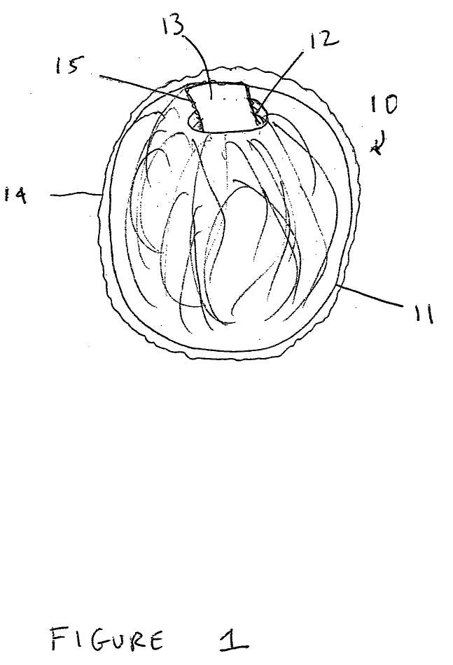

Referring now to the drawings, wherein like reference numerals refer to the same components across the several views, and in particular to FIG. 1, there is shown a vegetable food product 10. The vegetable food product 10 includes a lettuce head 11, a container of dressing or condiment 13, and wrapping 14. While the invention is described in one embodiment as a lettuce head, other salad vegetables such as cabbage, broccoli, cauliflower and loose lettuces such as butter, romaine, red, etc. are applicable to the present invention.

The lettuce head or vegetable product 11 includes a core 12, which is open to allow the placement of something inside of it. The lettuce head 11 is preferably a head of iceberg lettuce but it can be seen to one of ordinary skill in the art that the head could be of any various types of lettuce or other produce as noted above. Disposed within the core 12 of lettuce head 11 is a container of dressing or other condiment 13. There may be more than one container, perhaps up to six. The container of dressing or condiment 13 may be slightly larger than the core 12 and therefore overlap the outer leaves of the lettuce head 11 at overlap 15. In this manner, an amount of dressing or condiment may be included in the container of dressing or condiment 13 that is adequate to use on the entire lettuce head 11, even though the container of dressing or condiment 13 would not fit totally within the core 12. A wrapper 14 may be wrapped around the lettuce head 11 and the container of dressing or condiment 13 so as to encapsulate them and make the vegetable food product 10 easier for transportation.

The wrapper 14 may be of any type known to one of ordinary skill in the art, but in a preferred embodiment of the present invention, the wrapper 14 is a clear plastic transparent wrapper so as to advertise the contents inside the wrapper 14, mainly the lettuce head 11 and the container of dressing or condiment 13.

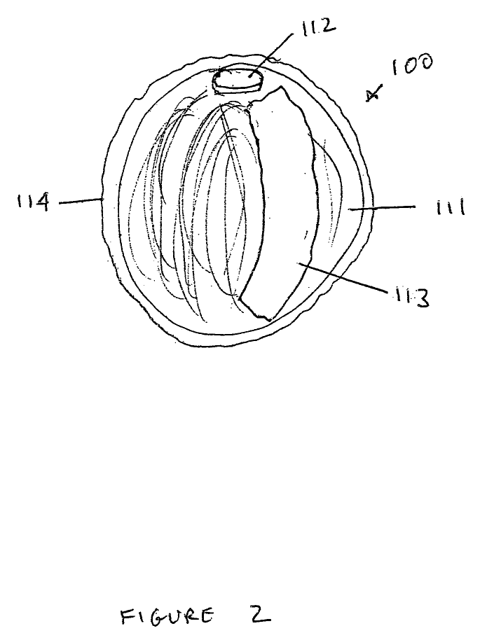

Referring now to FIG. 2, an alternative embodiment of the present invention is shown as vegetable food product 100. The vegetable food product 100 includes a lettuce head 111, a container of dressing or condiment 113, and a wrapper 114.

The lettuce head 111 is similar to the lettuce head 11, except that the core 112 has not been removed from lettuce head 111 in the same fashion as it has been removed from lettuce head 11. The container of dressing or condiment 113 is disposed about the periphery of lettuce head 111, and both the container of dressing or condiment 113 and the lettuce head 111 are wrapped with wrapper 114. The wrapper 114 is preferably a clear transparent plastic in a preferred embodiment of the invention, however, any suitable type of wrapper may be used as understood by one of ordinary skill in the art.

In this way, it is not necessary to core out the lettuce head 111, and the entire vegetable food product 111 can be produced more quickly and efficiently.

Regarding either lettuce head 11 or 111, either may be further sliced into wedges to allow for even quicker serving of the vegetable food product 10 or 100. In a preferred embodiment, for example, lettuce head 11 or 111 would be sliced into 4 equal size wedges as appropriate portions.

In view of the foregoing disclosure, some of the advantages of the present invention can be seen. For instance, a novel vegetable food product is disclosed. This vegetable food product allows for ease of preparation of a salad and does not require the shredding of the product prior to packaging. Not only is this easier on the consumer, but it also makes the product easier to produce in the field.

While the preferred embodiments of the present invention have been described and illustrated, modifications may be made by one of ordinary skill in the art without departing from the scope and spirit of the invention as defined in the appended claims. For example, although a head of lettuce is disclosed in the preferred embodiment, it can be readily seen that other vegetables may be substituted such as cabbage, broccoli, cauliflower and leaf lettuce and the like.

What is claimed is:

1. A vegetable food product, comprising:
a vegetable; and
at least one container of dressing or condiment mounted with the vegetable.

2. The vegetable food product of claim 1, further comprising wrapping around the vegetable the container of dressing or condiment.

3. The vegetable food product of claim 2, wherein the wrapping is transparent.

4. The vegetable food product of claim 2, wherein vegetable has its core removed.

5. The vegetable food product of claim 4, wherein the container of dressing or condiment is disposed within the core of the vegetable.

6. The vegetable food product of claim 5, wherein the vegetable is head of iceberg lettuce and the container of dressing or condiment is disposed in the core of the head of lettuce and extends beyond the core and overlaps the outer leaves of the head of lettuce.

7. The vegetable food product of claim 6, wherein the head of lettuce is cut into four equivalent wedges.

8. A vegetable food product, comprising:
a solid vegetable such as iceberg lettuce, cabbage, cauliflower, or broccoli;
a container of dressing or condiment disposed about the outer periphery of iceberg lettuce, cabbage, cauliflower, or broccoli; and
wrapping the iceberg lettuce, cabbage, cauliflower, or broccoli and the container of dressing or condiment.

9. The vegetable food product of claim 8, wherein the wrapping is transparent.

10. The vegetable food product of claim 8, wherein the solid vegetable is cut into four equivalent wedges.

11. A method of preparing a vegetable food product, comprising the steps of:
coring a salad vegetable such as iceberg lettuce, cabbage, broccoli or cauliflower;
inserting a container of dressing or condiment within the core of the salad vegetable; and

12. The method of preparing a vegetable food product of claim 11, further comprising the step of cutting the head of lettuce into four equivalent wedges.
